(19) United States
(12) Patent Application Publication
(10) Pub. No.: US 2006/0043196 A1
(43) Pub. Date: Mar. 2, 2006

(54) Air spring mount assembly with identification tag

(75) Inventor: Mark G. Trowbridge, Stow, OH (US)

Correspondence Address: WOOD, HERRON & EVANS, LLP, 2700 CAREW TOWER, 441 VINE STREET, CINCINNATI, OH, 45202, US

(73) Assignee: Goodyear Tire and Rubber Company

(21) Appl. No.: 10/927,851

(22) Filed: Aug. 27, 2004

(51) Int. Cl. G06K 19/00

(52) U.S. Cl. 235/487

(57) ABSTRACT

An air spring mount assembly includes an identification tag secured to the mount such that it is readily visible in service by inspection. The tag is clamped between an elastomeric member and a support plate that define a pressurizable chamber of the mount. Printed indicia, such as a part number, manufacturer's name, or graphics is disposed on the tag. In one embodiment, the tag is formed from a material comprising polymeric fibers that provide abrasion resistance and durability to the tag.

### FIELD OF THE INVENTION

The present invention relates generally to suspension systems, and more particularly to a fluid mount used in a suspension system.

### BACKGROUND OF THE INVENTION

Fluid suspension systems, including air springs, are used in various automotive and industrial applications to support loads and to isolate them from vibration. For example, air springs are typically used in Class 8 truck suspensions to accommodate the varying loads supported by the suspension and to provide isolation from road inputs. Conventional air springs include an elastomeric member that is crimped, swaged, or otherwise secured to one or more support plates such that the elastomeric member and support plates create a pressurizable chamber. The support plates are configured to facilitate securing the air spring to a vehicle or other structure that is desired to be mounted in an isolating fashion. In use, the fluid springs can be pressurized with air or other fluid to adjust the height of the mounted structure and to “tune” the mount to provide a desired isolation performance.

In most applications, fluid mounts are located beneath the structure to be supported. Because part number marking or other identification is commonly provided on the support plates, the mounts cannot be readily identified in the installation. Accordingly, when service is necessary, the supported structure must be removed and the mount examined to determine the manufacturer and/or part number so that a replacement part can be ordered. If the replacement part is not in stock, or is otherwise unavailable, the equipment or vehicle cannot be used and must remain in the disassembled configuration until a new part can be obtained and installed. In many applications, relative motion between the supported structure and the mounts abrades or otherwise degrades the markings on the support plates, making it difficult to determine the correct part number associated with the air spring. A need therefore exists for a fluid mount that overcomes these and other drawbacks of the prior art.

### SUMMARY OF THE INVENTION

The present invention provides a fluid mount, such as an air spring, for supporting suspension loads and which is configured so that the part number can readily be determined by visual inspection without having to remove the mount from its installation. In one embodiment, the fluid mount includes at least one support plate and a flexible elastomeric member coupled to the support plate to define a pressurizable chamber for receiving a working fluid, such as air. An identification tag is clamped between the support plate and the elastomeric member such that the tag extends outwardly from the clamped interface and along the surface of the elastomeric member, whereby the tag is readily visible on the mount while the mount is installed in an application. In another embodiment, an adhesive is provided on at least a portion of the tag to facilitate positioning the tag relative to the elastomeric member during manufacture of the fluid spring. Advantageously, the tag may be formed from a material that is wear and abrasion resistant so that the integrity of the markings on the tag will not become degraded during use.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view depicting a fluid air spring, including a tag according to the present invention;

FIG. 2 is a plan view of an exemplary tag of the present invention;

FIG. 3 is a partial cross-sectional view of the fluid air spring of FIG. 1; and

FIG. 4 is a partial cross-sectional view of another fluid air spring, similar to FIG. 3.

### DETAILED DESCRIPTION

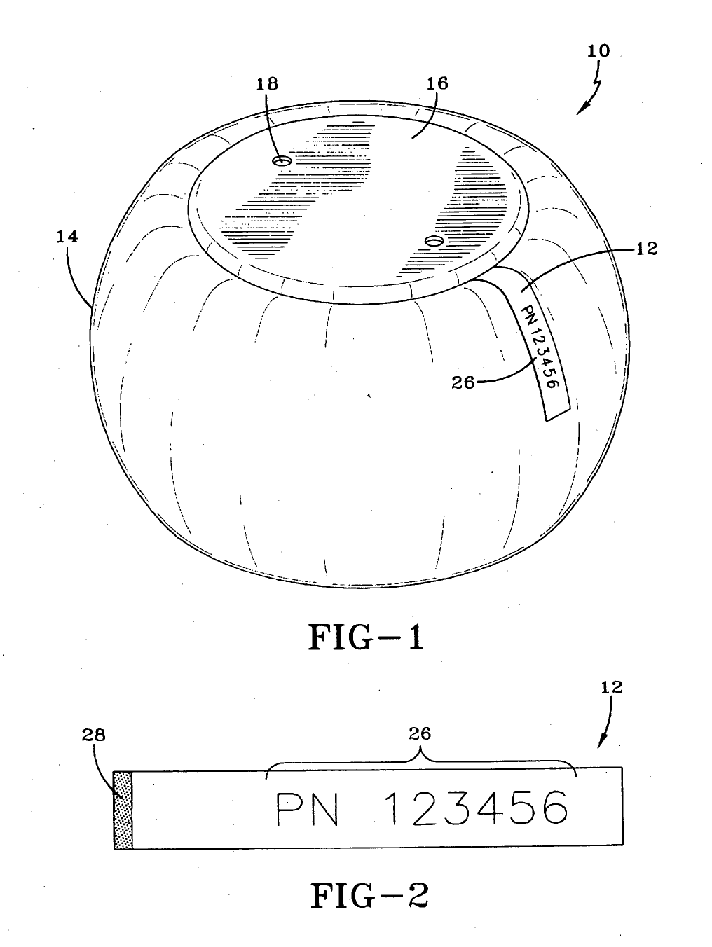

Referring now to FIG. 1, there is shown an exemplary fluid air spring 10 including an identification tag 12 according to the present invention. The fluid air spring 10 is formed from an elastomeric member 14, such as a sleeve or boot. The elastomeric member 14 is typically constructed from at least one layer of rubberized reinforcing cord and is secured at one end to an upper support plate 16, and at another end to a lower support plate (not shown), as known in the art, to form a pressurizable chamber. In service, the chamber may be pressurized with air, or air may be selectively expelled from the chamber to vary the effective spring rate of the air spring mount 10, as known in the art. In the embodiment shown in FIG. 1, the support plate 16 includes apertures 18 for receiving studs to facilitate mounting the air spring 10 in a given application. Alternatively, the air spring 10 may be provided with pins or threaded studs to facilitate mounting, as known in the art.

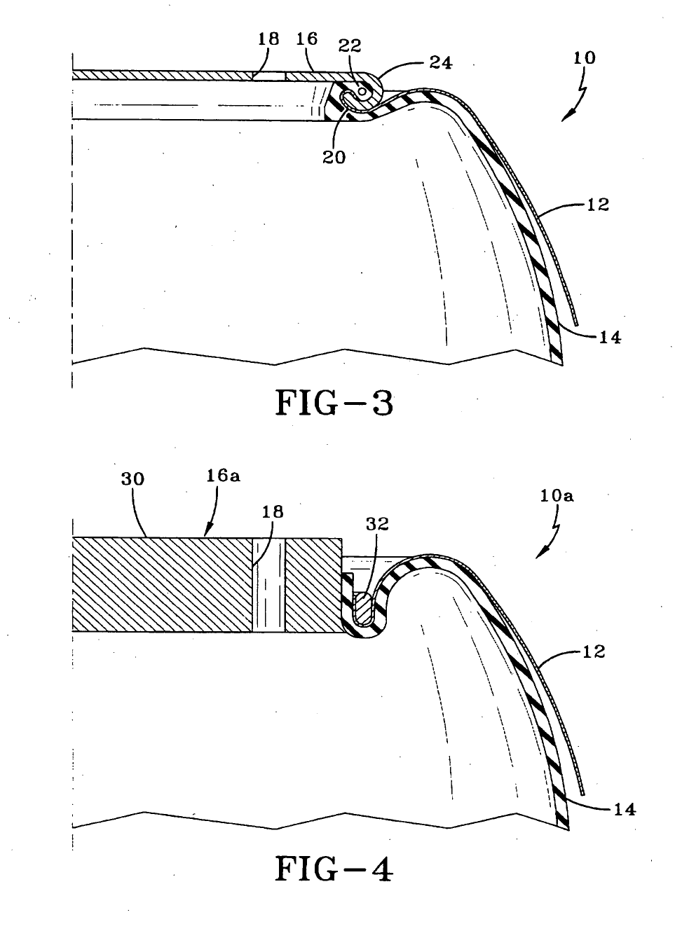

With continued reference to FIG. 1, and referring further to FIG. 2, the fluid air spring 10 further includes an identification tag 12 clamped between the support plate 16 and the elastomeric member 14. In the embodiment shown, the identification tag 12 is an elongate strip of material that extends from the clamped interface between the support plate 16 and the elastomeric member 14 such that the identification tag 12 extends along an outwardly facing surface of the elastomeric member 14. As shown more clearly in FIG. 3, a first end 20 of the identification tag 12 is mechanically locked between an upper bead section 22 of the elastomeric member 14 and the crimped end 24 of the support plate 16 such that the identification tag 12 remains securely fixed to the fluid air spring 10 even under severe operating conditions.

As depicted in FIGS. 1 and 2, printed indicia 26 such as the name of the manufacturer of the air spring and/or a part number or other identifier are printed on the tag 12 so that the indicia 26 may be readily viewable even when the air spring 10 is mounted for use in an application. In the embodiment shown, the identification tag 12 is formed from a fabric material comprising polymeric fibers that provide wear and abrasion resistance to the material. An exemplary material is Tyvek® material available from DuPont of Wilmington, Del. The indicia 26 may comprise letters, numerals, or other visible graphics printed onto or otherwise applied to the identification tag 12. In one embodiment, the printed indicia 26 are formed from a wax resin that is absorbed into the polymeric fibers that make up the tag material.

The identification tag 12 may further include adhesive 28 disposed on at least a portion of the tag 12. Advantageously, the adhesive 28 facilitates manufacture of the fluid air spring 10 by permitting the tag 12 to be adhered to the elastomeric member 14 or to the support plate 16 prior to crimping the elastomeric member 14 to the support plate 16. Accordingly, a method of forming a fluid air spring 10 includes positioning a tag 12, as described above, on a support plate 16 of an unassembled fluid air spring, positioning an elastomeric member 14 adjacent the support plate 16, and clamping the support plate 16 and tag 12 to the elastomeric member 14 such that the tag 12 is mechanically locked to the elastomeric member 14 and extends along an outer surface thereof.

While FIG. 3 depicts an air spring 10 that is formed by crimping the elastomeric member 14 to the mounting support plate 16, it will be recognized that fluid air springs according to the present invention may be formed by other methods. For example, FIG. 4 depicts a fluid air spring 10a wherein the support plate 16a includes a central body portion 30 and a ring 32 that is adapted to be swaged around the central body portion 30 to clamp the elastomeric member 14 to the central body portion 30. The identification tag 12 may be adhesively attached to the elastomeric member 14 or to the ring 32 prior to assembly such that after swaging, the identification tag 12 extends from the clamped area and outwardly over the elastomeric member 14 in a manner as described above.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A fluid spring for supporting suspension loads, comprising:
at least one support plate;
a flexible elastomeric member coupled to said support plate and cooperating with said support plate to define a pressurizable chamber; and
an identification tag formed from polymeric fibers and clamped between said support plate and said elastomeric member, said tag extending outwardly from the clamped interface and along an outwardly facing surface of said elastomeric member;
said tag visible on the fluid spring when the fluid spring is mounted for use.

2. The fluid spring of claim 1, further comprising printed indicia disposed on said tag to identify the fluid spring or its source.

3. The fluid spring of claim 1, further comprising an adhesive disposed on at least a portion of said tag to facilitate locating said tag relative to said elastomeric member prior to clamping said tag between said support plate and said elastomeric member.

4. (canceled)

5. The fluid spring of claim 2, wherein said printed indicia is formed from a wax resin that is absorbed into said polymeric fibers.

6. The fluid spring of claim 1, wherein said tag is formed from an abrasion resistant material.

7. A method of forming a fluid spring, comprising:
positioning a tag formed from polymeric fibers on one of a support member and an elastomeric member of an unassembled fluid spring;
positioning the elastomeric member proximate the support member; and
clamping the support member to the elastomeric member, such that the tag is mechanically locked to the elastomeric member and extends along an outer surface thereof.

8. The method of claim 7, further comprising:
applying indicia to the tag to identify at least one of the fluid spring or the source of the fluid spring.

9. The method of claim 7, wherein clamping the support member to the elastomeric member comprises crimping the support member to the elastomeric member.

10. The method of claim 7:
wherein the support member includes a central body portion and a ring adapted to be swaged around the central body portion; and
wherein clamping the support member to the elastomeric member comprises swaging the elastomeric member and tag between the ring and central body portion.
